(19) United States
(12) Patent Application Publication
(10) Pub. No.: US 2021/0264337 A1
(43) Pub. Date: Aug. 26, 2021

(54) RISK DECISION-MAKING METHOD AND APPARATUS

(71) Applicant: ADVANCED NEW TECHNOLOGIES CO., LTD., GEORGE TOWN (KY)

(72) Inventor: Binbin SONG, HANGZHOU (CN)

(21) Appl. No.: 17/320,081

(22) Filed: May 13, 2021

Related U.S. Application Data
(63) Continuation of application No. PCT/CN2020/070501, filed on Jan. 6, 2020.

(30) Foreign Application Priority Data
Mar. 8, 2019 (CN) 201910177003.5

(51) Int. Cl. G06Q 10/06; G06Q 10/10

(52) U.S. Cl. CPC G06Q 10/0635; G06Q 10/10

(57) ABSTRACT

A risk decision-making method comprises: receiving, by a local server, a risk decision-making request initiated by a local service system, the risk decision-making request comprising service information of a local service; performing, by a local server, a risk assessment on the local service using a first risk decision-making rule for the local service based on the service information of the local service, wherein the first risk decision-making rule is obtained from a central server; determining, by the local server, a first risk assessment result for the local service from the risk assessment; and determining, by the local server, a risk decision-making result for the local service based on the first risk assessment result.

### CROSS-REFERENCE TO RELATED APPLICATIONS

The present application is a continuation application of International Application No. PCT/CN2020/070501, filed with China National Intellectual Property Administration (“CNIPA”) on Jan. 6, 2020, and entitled “RISK DECISION-MAKING METHOD AND APPARATUS,” which is based on and claims priority to and benefits of Chinese Patent Application No. 201910177003.5, filed on Mar. 8, 2019. The entire contents of all of the above-identified applications are incorporated herein by reference.

### TECHNICAL FIELD

This specification relates to the field of computer technologies, and in particular, to risk decision-making methods and systems.

### BACKGROUND

Internet finance and fintech are expanding globally. Internet finance can be more open and flexible. As a result, risk management becomes particularly important. In the internet finance industry, many internet financial companies and start-ups in different countries and regions are trying to establish their own internet financial systems to provide local users with internet financial services.

Users of internet finance start-ups face risks of account hacking and asset theft. However, very few internet finance companies, especially internet finance start-ups, have a robust risk management team or mechanism. For those that do have a risk management team or mechanism, the risk management experience and capabilities of the team or the mechanism are usually inadequate. Therefore, solving the risk management problems of the companies lacking risk management experience and risk management capabilities is vital to the development prospects of these internet finance companies.

### SUMMARY

This specification provides risk decision-making methods and apparatuses. By using the risk decision-making method and apparatus, risk assessment may be performed on a local service using a risk decision-making rule from a central server, which can improve the risk management capabilities of a company that originally has no risk management capabilities or that has insufficient risk management capabilities. The technical solution are as follows:

Embodiments of this specification provide a risk decision-making method, including: receiving, by a local server, a risk decision-making request initiated by a local service system, the risk decision-making request comprising service information of a local service; performing, by a local server, a risk assessment on the local service using a first risk decision-making rule for the local service based on the service information of the local service, wherein the first risk decision-making rule is obtained from a central server; determining, by the local server, a first risk assessment result for the local service from the risk assessment; and determining, by the local server, a risk decision-making result for the local service based on the first risk assessment result.

In some embodiments, the first risk decision-making rule includes one or more labels corresponding to one or more local merchants, and the first risk decision-making rule for each of the one or more merchants is packaged in the central server based on the one or more labels. In some embodiments, the method further comprises: performing, by the local server, a second risk assessment on the local service using a second risk decision-making rule based on the service information or the first risk assessment result, wherein the second risk decision-making rule is created locally by the local server, and determining, by the local server, a second risk assessment result for the local service from the second risk assessment, wherein the determining a risk decision-making result for the local service based on the first risk assessment result further comprises: determining the risk decision-making result for the local service based on the first risk assessment result and the second risk assessment result.

In some embodiments, the method further comprises: adjusting, by the local server, the second risk decision-making rule according to the risk decision-making result and the second risk assessment result in response to a determination that the determined risk decision-making result is different from the second risk assessment result.

In some embodiments, the determining the risk decision-making result for the local service based on the first risk assessment result and the second risk assessment result further comprises: determining the risk decision-making result for the local service based on the first risk assessment result and the second risk assessment result according to a preset rule, wherein the preset rule comprises: determining the first risk assessment result as the risk decision-making result for the local service; determining the second risk assessment result as the risk decision-making result for the local service; or determining a risk assessment result with a higher priority in the first risk assessment result and the second risk assessment result as the risk decision-making result for the local service.

In some embodiments, the method further comprises: determining a service category of the local service based on the service information of the local service; and obtaining the first risk decision-making rule based on the service category of the local service.

In some embodiments, the method further comprises: determining a service risk category of the local service based on the service information of the local service; and obtaining the first risk decision-making rule based on the service risk category of the local service.

In some embodiments, the method further comprises: obtaining the second risk decision-making rule based on the service risk category of the local service.

In some embodiments, the risk assessment result for the local service is one of the following: a rejection of the local service; a further verification of the local service; and an acceptance of the local service.

Embodiments of this specification further provide a system comprising one or more processors and one or more non-transitory computer-readable memories coupled to the one or more processors and configured with instructions executable by the one or more processors to cause the system to perform operations, including: receiving, by a local server, a risk decision-making request initiated by a local service system, the risk decision-making request comprising service information of a local service; performing, by a local server, a risk assessment on the local service using a first risk decision-making rule for the local service based on the service information of the local service, wherein the first risk decision-making rule is obtained from a central server; determining, by the local server, a first risk assessment result for the local service from the risk assessment; and determining, by the local server, a risk decision-making result for the local service based on the first risk assessment result.

Embodiments of this specification further provide one or more non-transitory computer-readable storage media storing instructions executable by one or more processors, wherein execution of the instructions causes the one or more processors to perform operations comprising: receiving, by a local server, a risk decision-making request initiated by a local service system, the risk decision-making request comprising service information of a local service; performing, by a local server, a risk assessment on the local service using a first risk decision-making rule for the local service based on the service information of the local service, wherein the first risk decision-making rule is obtained from a central server; determining, by the local server, a first risk assessment result for the local service from the risk assessment; and determining, by the local server, a risk decision-making result for the local service based on the first risk assessment result.

It should be understood that the foregoing general description and detailed description in the following are merely exemplary and explanative, and cannot constitute a limitation to the embodiments of this specification.

In addition, any one of the embodiments of this specification does not need to achieve all the foregoing effects.

### BRIEF DESCRIPTION OF THE DRAWINGS

To describe the technical solutions in the embodiments of this specification or in the existing technologies more clearly, the following briefly describes the accompanying drawings required for describing the embodiments or the existing technologies. Apparently, the accompanying drawings in the following description show merely some of the embodiments of this specification, and a person of ordinary skill in the art may still derive other drawings from the accompanying drawings.

FIG. 1 is a flowchart of an example risk decision-making method, according to some embodiments of this specification.

FIG. 2 is a schematic of an example risk decision-making system, according to some embodiments of this specification.

FIG. 3 is a flowchart of an example risk decision-making method using two risk decision-making rules, according to some embodiments of this specification.

FIG. 4 is a flowchart of an example risk decision-making method using service risk categories, according to some embodiments of this specification.

FIG. 5 is a schematic of an example risk decision-making apparatus, according to some embodiments of this specification.

FIG. 6 is a schematic of an example risk decision-making apparatus, according to some embodiments of this specification.

FIG. 7 is a schematic of an example computing device, according to some embodiments of this specification.

### DETAILED DESCRIPTION

The following describes details of embodiments of this specification with reference to the accompanying drawings. The accompanying drawings show some embodiments of this specification, and this specification may be implemented in various manners and is not limited by the embodiments described herein. Rather, these embodiments are provided, so that this specification is more thoroughly understood and the scope of this specification is completely conveyed to a person skilled in the art.

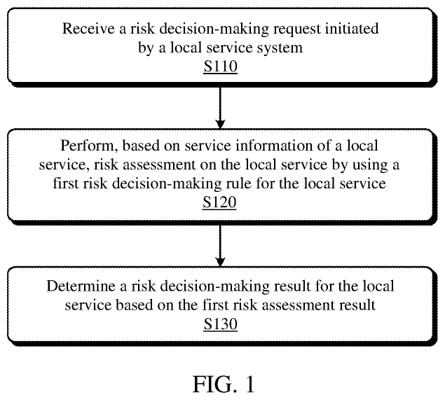

FIG. 1 is a flowchart of an example risk decision-making method, according to some embodiments of this specification. In some embodiments, entities related to the risk decision-making method shown in FIG. 1 can include a local service system, a local server, and a central server. In some embodiments, the risk decision-making method shown in FIG. 1 can be performed by the local server.

As shown in FIG. 1, in step 110, a risk decision-making request initiated by a local service system is received. In some embodiments, the risk decision-making request includes service information of a local service. In some embodiments, the service information of the local service may include, for example, device information, user information, bank card information, or account information corresponding to the local service.

In some embodiments, the local service system is a part of an internet finance company or start-up. In some embodiments, the local service system is a service system at the local, such as a third-party payment system for a company (e.g., a start-up company) providing internet finance services. In some embodiments, when a local service occurs in the local service system, the local service system can trigger a risk decision-making request to request risk decision-making on the current local service.

In step S120, a risk assessment is performed on the local service based on the service information of the local service. In some embodiments, the risk assessment is performed using a first risk decision-making rule for the local service. The first risk decision-making rule can determine a first risk assessment result for the local service. In some embodiments, the first risk decision-making rule can be obtained from the central server. In some embodiments, the local service may correspond to one or more service categories, such as a transfer service (e.g., a monetary transfer service), a payment service, or a top-up service (e.g., adding more payment credit into an account or recharging). In some embodiments, the first risk decision-making rule for the local service may be a first risk decision-making rule for a service category to which the local service belongs. In some embodiments, the first risk rule for the local service may be universal for the one or more service categories.

In some embodiments, the central server is a server that provides risk management services for a local enterprise. For example, the central server may be a server of an enterprise with risk management capabilities. In some embodiments, the central server may be a server of an enterprise with more risk management capabilities than the company providing internet finance services. In some embodiments, a risk management team or mechanism on the central server side can configure a risk decision-making rule that may be used by the local service system and distribute the rule to the local. In some embodiments, the risk decision-making rule being configured can be the first decision-making rule.

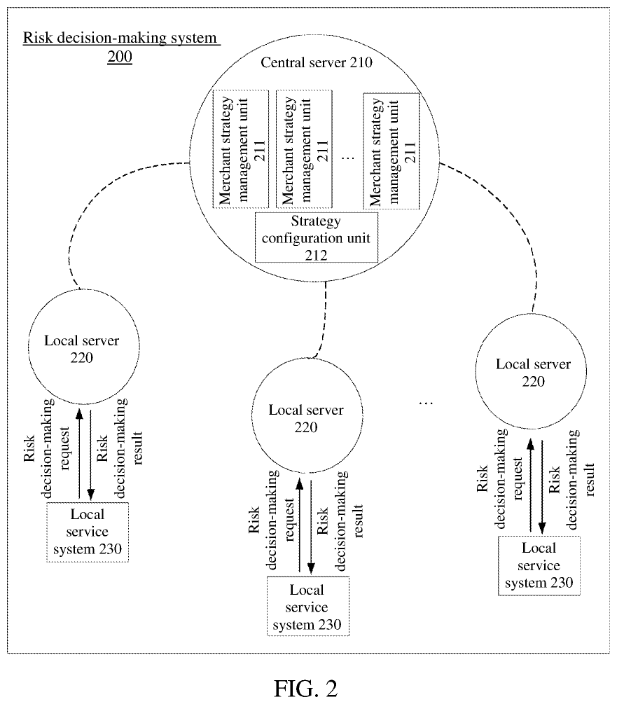

FIG. 2 is a schematic of an example risk decision-making system, according to some embodiments of this specification. It is appreciated that risk decision-making system 200 shown in FIG. 2 can be configured to perform the risk decision-making method shown in FIG. 1. As shown in FIG. 2, a central server 210 can include one or more merchant strategy management units 211. In some embodiments, each of the one or more merchant strategy management units 211 can correspond to a local merchant. The local merchant may be a local internet finance company (e.g., a start-up). In some embodiments, each local merchant can have a local server 220. In some embodiments, a strategy configuration unit 212 of the central server 210 can configure first risk decision-making rules for corresponding local merchants and one or more variables for calling the first risk decision-making rules.

In some embodiments, each of the first risk decision-making rules and the one or more variables may have at least one label, and each label can correspond to a local merchant. In some embodiments, if the first risk decision-making rules for the local merchants are not shared with each other, each first risk decision-making rule may have a label to identify the local merchant corresponding to the first risk decision-making rule. In some embodiments, some first risk decision-making rules may be shared by a plurality of merchants. The shared first risk decision-making rule may have labels corresponding to a plurality of local merchants. In some embodiments, when there are a plurality of labels for a first risk decision-making rule, the first risk decision-making rule can be reused, thereby improving the configuration efficiency of the first risk decision-making rule. In some embodiments, the risk management team or mechanism of the central server can configure the same first risk decision-making rule for a plurality of local merchants having a same attribute, and assign a plurality of labels corresponding to the plurality of local merchants to the first risk decision-making rule.

In some embodiments, the label of each merchant may be determined by one or more risk management personnel on the central server side. In some embodiments, the label of each merchant may be sent to the central server by the local server of the local merchant. In some embodiments, the one or more risk management personnel on the central server side can assign labels to first risk decision-making rules and variables when configuring the first risk decision-making rules.

In some embodiments, after the strategy configuration unit 212 configures the first risk decision-making rules, a packaging process can be performed on the first risk decision-making rules based on the labels of the first risk decision-making rules. For example, during the packaging process, the first risk decision-making rules and variables with the same label may be packaged together. As a result, a first risk decision-making rule with a plurality of labels can be packaged into a plurality of risk decision-making rule packages based on the plurality of labels. In some embodiments, the packaged first risk decision-making rules may be stored in the one or more merchant strategy management units 211 corresponding to the local merchants. In some embodiments, each of the plurality of labels correspond to one of the plurality of local merchants. In some embodiments, the local merchants can log in to corresponding management platforms to obtain respective first risk decision-making rules. In some embodiments, a packaged first risk decision-making rule may be sent to a corresponding local merchant that corresponds to the label of the packaged first risk decision-making rule. In some embodiments, the one or more merchant strategy management units 211 may be physically isolated from each other. For example, each local merchant may only obtain the respective packaged first risk decision-making rule after logging in to the management platform.

In some embodiments, the strategy configuration unit 212 may provide functions such as adding, modifying, deleting, or querying a risk decision-making rule or variable. In some embodiments, the strategy configuration unit 212 may have a preliminary audit or review function for a risk decision-making rule or variable. In some embodiments, staff of the risk management team or the risk management mechanism on the side of the central server 210 can log in to a management backend of the central server 210, and configure or update the first risk decision-making rules and variables through the strategy configuration unit 212. For example, when the risk management team or mechanism of the local merchant believes that a first risk decision-making rule or a corresponding variable requires update such as adding, modifying, or deleting, a request to update may be sent to the central server via the local server 220. In some embodiments, after receiving the request, the risk management team or mechanism on the central server side may update the first risk decision-making rule for the corresponding local merchant, and repackage and send the rule to the local server 220. In some embodiments, the risk management team or mechanism on the central server side can repackage and then store the rule in the corresponding local merchant strategy management unit, and the rule can be downloaded by the risk management team or mechanism of the local merchant.

In some embodiments, the local server 220 may load the obtained first risk decision-making rule into a local database. In some embodiments, a local risk control team or mechanism may configure the obtained first risk decision-making rule in the local server. In some embodiments, when a local service system 230 triggers a risk decision-making request, the local server may call the first risk decision-making rule from the central server 210 in accordance with a prescribed variable, so that risk assessment can be performed on the local service based on the service information of the local service.

In some embodiments, the risk assessment result may be, for example, a rejection of the local service. For example, when the risk assessment result indicates that a transfer service has a higher risk of asset theft, the execution of the transfer service may be rejected, thereby protecting the security of assets for the user. In some embodiments, the risk assessment result may be a further verification of the local service. For example, when a transfer service has a risk of asset theft but the risk is not too high, the transfer service may be further verified. Based on the result of the further verification, it may be determined whether to allow the execution of the corresponding local service. In some embodiments, if the local service has been determined (e.g., through the risk assessment result,) to have no risk or a lower risk, the risk assessment result may be an acceptance of the local service. As a result, the local service may be allowed to be executed.

In some embodiments, the risk assessment result may further include a risk information serial number or a risk score for the local service. For example, the risk information serial number may represent various types of specific risk content. In some embodiments, a database that includes more detailed descriptions and recommended response strategies for the various types specific risk content can be used. Therefore, the foregoing content can be obtained by searching the database according to the risk information serial number.

Referring back to FIG. 1, in step S130, after the first risk assessment result is obtained, a risk decision-making result for the local service can be determined based on the first risk assessment result. In some embodiments, the first risk assessment result may be determined as the risk decision-making result for the local service.

In some embodiments, in the process of determining the risk decision-making result for the local service, additional information can be collected. For example, the additional information to be collected can include service information, an intermediate risk assessment result, a final risk decision-making result, and other information. In some embodiments, the collected additional information can be stored in the database. In some embodiments, the information collected and stored in the database can be used for analysis by risk management personnel or mechanism.

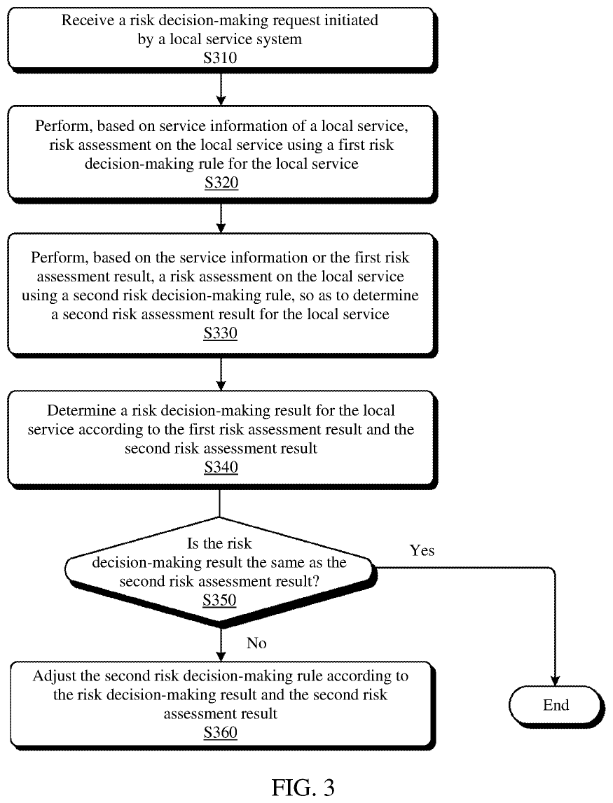

FIG. 3 is a flowchart of an example risk decision-making method using two risk decision-making rules, according some embodiments of this specification. It is appreciated that the risk decision-making method shown in FIG. 3 can be performed by the risk decision-making system 200 shown in FIG. 2 (e.g., the one or more local servers 220).

In step S310, a risk decision-making request initiated by a local service system is received. In some embodiments, the local service system can be one of the one or more local service systems 230 shown in FIG. 2.

In step S320, a risk assessment is performed on a local service using a first risk decision-making rule from a central server. In some embodiments, the central server can be the central server 210 shown in FIG. 2.

In step S330, after the risk decision-making request is received a risk assessment is performed on the local service based on service information or a first risk assessment result using a second risk decision-making rule, so as to determine a second risk assessment result for the local service. In some embodiments, the second risk decision-making rule is created locally.

In some embodiments, if the local risk management team or mechanism is capable of risk management, the second risk decision-making rule configured locally can be used to determine the second risk assessment result of the local service based on the service information. In some embodiments, the second risk decision-making rule configured by the local risk management team may have a lower accuracy. As a result, when the second risk decision-making rule is used to determine the second risk assessment result, the first risk assessment result determined above may be used as a reference, or the second risk assessment result may be obtained using only the first risk assessment result. For example, when the first risk assessment result includes a risk score, the locally configured second risk decision-making rule may indicate a rejection of the execution of the local service when the risk score is greater than a threshold.

In step S340, after the first risk assessment result and the second risk assessment result are determined, a risk decision-making result for the local service is determined according to the first risk assessment result and the second risk assessment result. In some embodiments, the risk decision-making result is determined based on one or more preset rules. In some embodiments, if the risk management capabilities of the local risk management team or mechanism are inadequate, the first risk assessment result determined by the first risk decision-making rule can be used as the risk decision-making result for the local service. In some embodiments, if the risk management capabilities of the local risk management team or mechanism are adequate, the second risk assessment result determined by the locally configured second risk decision-making rule can be used as the risk decision-making result for the local service.

In some embodiments, the risk decision-making result may be determined according to a priority order of the first risk assessment result and the second risk assessment result. For example, the priority order may be that “a rejection of the local service” has a higher priority than “a further verification of the local service,” and “a further verification of the local service” has a higher priority than “an acceptance of the local service.” If, for example, the first risk assessment result corresponds to “a further verification of the local service,” and the second risk assessment result corresponds to “a rejection of the local service,” the second risk assessment result has a higher priority than the first risk assessment result. As a result, the second risk assessment result with the higher priority may be determined as the risk decision-making result for the local service.

In some embodiments, the priorities of the risk assessment results may be determined based on evaluating the strictness of the results. For example, when risk assessment is performed, “a rejection of the local service” is stricter than “a further verification of the local service,” and “a further verification of the local service” is stricter than “an acceptance of the local service.” The priority order of the risk assessment results may be determined in a descending order of “a rejection of the local service,” “a further verification the local service,” and “an acceptance of the local service.” Priorities determined based on evaluating the strictness of the results can improve the security of the risk decision-making result.

In some embodiments, if the risk assessment results include risk scores, a determination of an average value of the risk scores (e.g., an arithmetic mean or a weighted arithmetic mean) may be performed on the risk scores in the first risk assessment result and the second risk assessment result, so as to determine the risk decision-making result for the local service.

Referring back to FIG. 3, in step S350, after the risk decision-making result for the local service is determined according to the first risk assessment result and the second risk assessment result, it is determined whether the determined risk decision-making result is the same as the second risk assessment result obtained locally. If the determined risk decision-making result is not the same as the second risk assessment result, step 360 is executed.

In step 360, if the determined risk decision-making result is different from the second risk assessment result obtained locally, the second risk decision-making rule may be adjusted according to the risk decision-making result and the second risk assessment result. For example, when confidence in the locally configured second risk decision-making rule is insufficient, the first risk assessment result can be determined as the risk decision-making result. When the second risk assessment result is different from the finally determined risk assessment result, the second risk decision-making rule is adjusted. As a result, the accuracy of the local second risk decision-making rule can be gradually improved. In some embodiments, after the first risk assessment result is determined, and the second risk assessment result is obtained using the second risk decision-making rule based on the first risk assessment result. If the determined risk decision-making result is different from the second risk assessment result, the second risk decision-making rule may be adjusted based on the determined risk decision-making result. In some embodiments, the adjustment of the second risk decision-making rule includes adjusting a threshold or other parameters of the second risk decision-making rule. For example, the parameters involved in determining the risk score for the second risk decision-making rule can be adjusted.

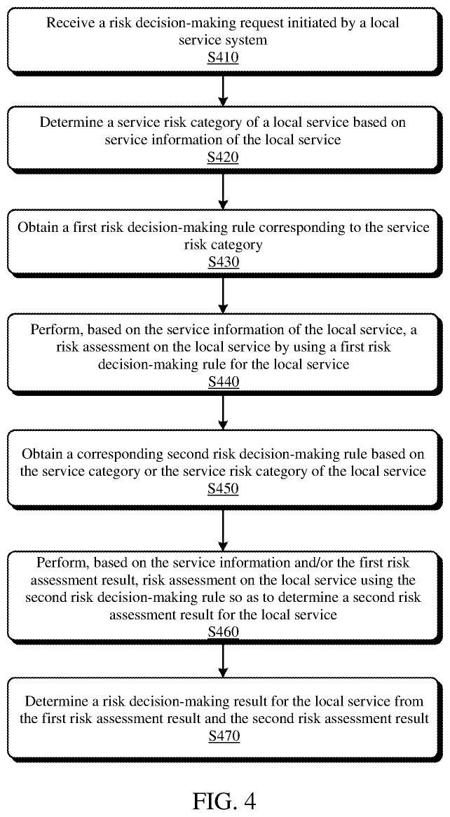

In some embodiments, the risk decision-making rule may correspond to a risk category of the local service. FIG. 4 is a flowchart of an example risk decision-making method using service risk categories, according to some embodiments of this specification. It is appreciated that the risk decision-making method shown in FIG. 4 can be performed by the risk decision-making system 200 shown in FIG. 2 (e.g., the one or more local servers 220).

In step S410, a risk decision-making request initiated by a local service system is received. In some embodiments, the local service system is one of the one or more local service systems 220 shown in FIG. 2.

In step S420, a service risk category of a local service is determined based on service information of the local service. The service risk category may include, for example, malicious marketing or fraud. In some embodiments, historical data can be collected, and a service risk classification model can be trained using the historical data. The service risk model can be used to classify service information to obtain the service risk category of the local service. In some embodiments, the service risk category of the local service may be a service risk with the highest occurrence frequency of each local service. For example, for a transfer service, a service risk with the highest occurrence frequency may be fraud. As a result, the service risk category for the transfer service can be determined to be fraud. In some embodiments, a service category of the local service can be determined.

In step S430, after the service risk category of the local service is determined, a first risk decision-making rule corresponding to the service risk category is obtained. In some embodiments, the first risk decision-making rule corresponding to the service risk category is obtained based on the service category or the service risk category.

In step S440, a risk assessment is performed on the local service using the obtained first risk decision-making rule corresponding to the service risk category so as to determine a first risk assessment result for the local service.

In some embodiments, in step S450, a second risk decision-making rule corresponding to the service risk category is obtained. In some embodiments, the second risk decision-making rule corresponding to the service risk category is obtained based on the service category or the service risk category.

In some embodiments, the first risk decision-making rule obtained from the server and the locally configured second risk decision-making rule may correspond to different service categories. In some embodiments, the first decision-making rule obtained from the server and the locally configured second risk decision-making rule may correspond to different service risk categories. In some embodiments, risk decision-making rules for different service categories may be obtained. In some embodiments, a risk decision-making rule corresponding to a determined service risk category may be obtained from risk decision-making rules that correspond to different service categories. In some embodiments, a risk decision-making rule corresponding to a determined service risk category may alternatively be obtained regardless of the service category.

Referring back to FIG. 4, in step S460, a risk assessment is performed on the local service using the obtained second risk decision-making rule corresponding to the service risk category so as to determine a second risk assessment result for the local service.

In step S470, a risk decision-making result for the local service is determined from the first risk assessment result and the second risk assessment result. In some embodiments, the risk decision-making result is determined based on a preset rule.

In some embodiments, the service risk category of the local service is determined and risk assessment is performed using the risk decision-making rule corresponding to the service risk category, which improves the accuracy and the efficiency of the service risk assessment.

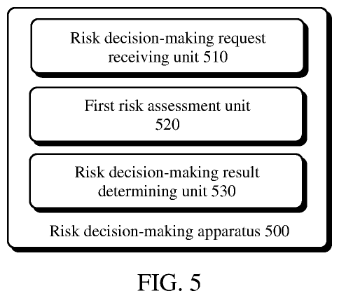

FIG. 5 is a schematic of a risk decision-making apparatus, according to some embodiment of this specification. As shown in FIG. 5, a risk decision-making apparatus 500 can include a risk decision-making request receiving unit 510, a first risk assessment unit 520, and a risk decision-making result determining unit 530. In some embodiments, the risk decision-making request receiving unit 510, the first risk assessment unit 520, and/or the risk decision-making result determining unit 530 can include software modules that can be executed by a processor to implement the risk determination functionalities.

In some embodiments, the risk decision-making request receiving unit 510 is configured to receive a risk decision-making request initiated by a local service system. The risk decision-making request can include service information of a local service. In some embodiments, the first risk assessment unit 520 is configured to perform, for the risk decision-making request sent by the local service system, a risk assessment on the local service based on the service information of the local service included in the risk decision-making request and by using a first risk decision-making rule from the central server, so as to determine a first risk assessment result for the local service. In some embodiments, after the first risk assessment result is determined, the risk decision-making result determining unit 530 is configured to determine a risk decision-making result for the local service based on the first risk assessment result.

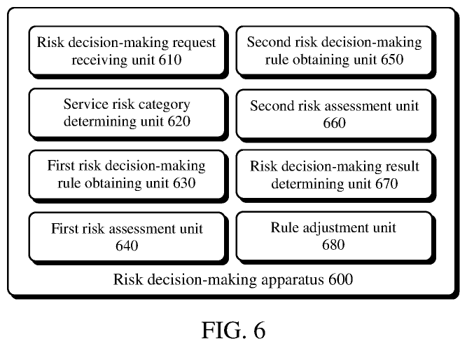

FIG. 6 is a schematic of a risk decision-making apparatus, according to some embodiments of this specification. As shown in FIG. 6, a risk decision-making apparatus 600 can include a risk decision-making request receiving unit 610, a service risk category determining unit 620, a first risk decision-making rule obtaining unit 630, a first risk assessment unit 640, a second risk decision-making rule obtaining unit 650, a second risk assessment unit 660, a risk decision-making result determining unit 670, and a rule adjustment unit 680. In some embodiments, the risk decision-making request receiving unit 610, the service risk category determining unit 620, the first risk decision-making rule obtaining unit 630, the first risk assessment unit 640, the second risk decision-making rule obtaining unit 650, the second risk assessment unit 660, the risk decision-making result determining unit 670, or the rule adjustment unit 680 can include software modules that can be executed by a processor to implement the risk determination functionalities.

In some embodiments, the risk decision-making request receiving unit 610 is configured to receive a risk decision-making request initiated by a local service system. In some embodiments, the risk decision-making request includes service information of a local service. In some embodiments, the service risk category determining unit 620 is configured to determine a service risk category of the local service based on the service information of the local service. In some embodiments, the service risk category of the local service is determined before a first risk assessment result for the local service is determined based on the service information of the local service using a first risk decision-making rule obtained from a central server. In some embodiments, after the service risk category is determined, the first risk decision-making rule obtaining unit 630 is configured to obtain the first risk decision-making rule corresponding to the determined service risk category based on a service category or the service risk category of the local service. In some embodiments, the first risk assessment unit 640 is configured to perform a risk assessment on the local service using the obtained first risk decision-making rule corresponding to the service risk category so as to determine a first risk assessment result for the local service.

In some embodiments, the second risk decision-making rule obtaining unit 650 is configured to obtain a corresponding second risk decision-making rule based on the service risk category of the local service. In some embodiments, the corresponding second risk decision-making rule is obtained before a risk assessment is performed on the local service based on the service information or the first risk assessment result using the second risk decision-making rule. In some embodiments, the second risk assessment unit 660 is configured to perform a risk assessment on the local service based on the obtained second risk decision-making rule corresponding to the determined service risk category so as to obtain a second risk assessment result.

In some embodiments, after the first risk assessment result and the second risk assessment result are determined, the risk decision-making result determining unit 670 may be configured to determine a risk decision-making result for the local service according to the first risk assessment result and the second risk assessment result. In some embodiments, the first risk assessment result may be determined as the risk decision-making result for the local service, or the second risk assessment result may be determined as the risk decision-making result for the local service. In some embodiments, the risk decision-making result can be determined based on a preset rule. For example, a risk assessment result with a higher priority (e.g., between the first risk assessment result and the second risk assessment result) may be determined as the risk decision-making result for the local service. In some embodiments, the risk assessment result for the local service may be a rejection on the local service, a further verification of the local service, or an acceptance of the local service.

In some embodiments, after the risk decision-making result is obtained, the rule adjustment unit 680 is configured to adjust the second risk decision-making rule. In some embodiments, the second risk decision-making rule is adjusted according to the risk decision-making result and the second risk assessment result if the determined risk decision-making result is different from the second risk assessment result.

It should be noted that one or more units shown in FIG. 6 may be removed from the risk decision-making apparatus 600. For example, the risk decision-making apparatus 600 may not include the service risk category determining unit 620, the first risk decision-making rule obtaining unit 630, or the second risk decision-making rule obtaining unit 650. In another example, the risk decision-making apparatus 600 may not include the rule adjustment unit 680.

It is appreciated that the risk decision-making system 200 shown in FIG. 2, the risk decision-making apparatus 500 shown in FIG. 5, or the risk decision-making apparatus 600 shown in FIG. 6 can be implemented in hardware, or in software, or a combination of hardware and software.

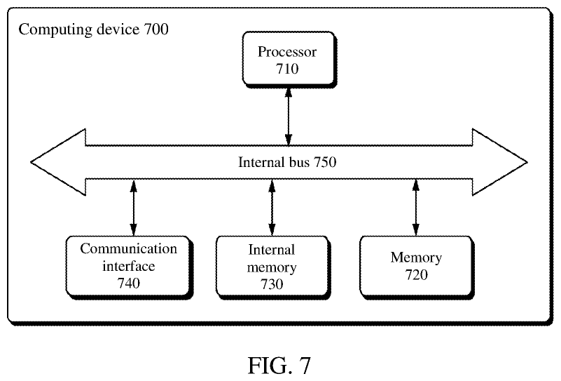

FIG. 7 is a schematic of an example risk decision-making computing device that can implement the methods and apparatus as described above and shown in FIGS. 1-6, according to some embodiments of this specification. As shown in FIG. 7, a computing device 700 may include a processor 710, a memory 720, an internal memory 730, a communication interface 740, and an internal bus 750.

In some embodiments, the processor 710 may be implemented in a manner of a general central processing unit (CPU), a microprocessor, an application-specific integrated circuit (ASIC), or one or more integrated circuits, and is configured to execute a related program to implement the technical solutions provided in the embodiments of this specification.

In some embodiments, the memory 720 may be implemented in a form of a read-only memory (ROM), a random access memory (RAM), a static storage device, or a dynamic storage device. The memory 720 may store an operating system and another application program. When the technical solutions provided in the embodiments of this specification are implemented by means of software or firmware, related program code can be stored in the memory 720 and can be executed by processor 710.

The communication interface 740 can be configured to connect to a communication module (not shown in the figure) and to implement communication interaction between the device and another device. The communication module may implement communication in a wired manner (such as a USB and a network cable), or may implement communication in a wireless manner (such as a mobile network, WiFi, and Bluetooth).

The bus 750 can include a path for transmitting information between the components (for example, the processor 710, the memory 720, the internal memory 730, and the communication interface 740) of the device.

In some embodiments, although the computing device 700 shows only the processor 710, the memory 720, the internal memory 730, the communication interface 740, and the bus 750, in a specific implementation process, the device may further include other components required by normal running. For example, the computing device 700 can further include an input/output interface. In addition, a person skilled in the art may understand that the device may alternatively include only components necessary for implementing the solution of the embodiments of this specification and not necessarily include all components shown in the figure.

In some embodiments, the computing device 700 may include a personal computer, a server computer, a workstation, a desktop computer, a laptop computer, a notebook computer, a mobile computing device, a smart phone, a tablet computer, a cellular phone, a personal digital assistant (PDA), a handheld apparatus, a messaging device, a wearable computing device, a consumer electronic device, and the like.

In some embodiments, a computer-readable storage medium storing a computer program is provided. The program, when executed by a process, can implement any of the previously described methods.

In some embodiments, the computer-readable medium includes a volatile medium and a non-volatile medium, a removable medium and a non-removable medium, which may implement storage of information by using any method or technology. The information may be a computer-readable instruction, a data structure, a module of a program, or other data. Examples of computer storage media include, but are not limited to, a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition in the present disclosure, the computer readable medium does not include transitory computer readable media (transitory media), such as a modulated data signal and a carrier. In some embodiments, the computer-readable storage medium can be a part of the memory 720 shown in FIG. 7, and the computer program stored in the computer-readable storage medium can be executed by the process 710 shown in FIG. 7.

With the risk decision-making methods and apparatuses described above, a first risk decision-making rule issued from a central server to the local server may be used to perform risk assessment on a local service, and the first risk decision-making rule may be configured on the central server by a team or mechanism with sufficient risk management experience and risk management capabilities. As a result, the risk management capabilities of the team or mechanism with sufficient risk management experience and risk management capabilities can enable an enterprise with insufficient risk management capabilities to carry out secure risk management.

With the risk decision-making methods and apparatuses described above, a risk assessment can be performed on the local service using a locally configured second risk decision-making rule, which enables a local risk management team or mechanism to independently configure the second risk decision-making rule according to actual conditions. Then a final risk decision-making result can be obtained based on an assessment result of the first risk decision-making rule from the central server and an assessment result of the locally configured second risk decision-making rule, so that the risk decision-making result can meet a local need and local risk management capabilities can be improved without compromising the flexibility of risk management (e.g., at the central server). In addition, the risk assessment can be performed according to the first risk assessment result when the locally configured second risk decision-making rule is used for risk assessment, which can reduce the difficulty of configuring the local second risk decision-making rule and improves the accuracy of risk assessment using the local second risk decision-making rule.

With the risk decision-making methods and apparatuses described above, the second risk decision-making rule can be adjusted according to the determined risk decision-making result and the locally configured second risk assessment result. For example, the second risk decision-making rule can be adjusted when the determined risk decision-making result is different from the second risk assessment result. The adjustment can improve the accuracy of the locally configured second risk decision-making result, and enables the local team or mechanism to continuously improve the risk management capabilities in the risk management practice.

With the risk decision-making methods and apparatuses described above, the service risk category of the local service is determined and risk assessment is performed on the local service using the risk decision-making result corresponding to the service risk category, which can improve the accuracy and the efficiency of the risk decision-making.

It may be learned from description of the foregoing implementations that, a person skilled in the art may clearly understand that the embodiments of this specification may be implemented by using software in addition to a necessary universal hardware platform. Based on such an understanding, the technical solutions of the embodiments of this specification essentially or the part contributing to the existing technologies may be implemented in a form of a software product. The computer software product may be stored in a storage medium, such as a ROM/RAM, a hard disk, or an optical disc, and includes a plurality of instructions for instructing a computer device (which may be a personal computer, a server, or a network device) to perform the methods described in the embodiments or some parts of the embodiments of this specification.

The system, the method, the module or the unit described in the foregoing embodiments may be implemented by a computer chip or an entity, or implemented by a product having a certain function. A typical implementation device is a computer, and the specific form of the computer may be a personal computer, a laptop computer, a cellular telephone, a camera phone, a smartphone, a personal digital assistant, a media player, a navigation device, an email transceiver device, a game console, a tablet computer, a wearable device, or a combination thereof.

In this specification, the embodiments are described in a progressive manner Reference may be made to each other for the same or a similar part of the embodiments. Each embodiment focuses on a difference from other embodiments. Especially, apparatus and device embodiments are basically similar to a method embodiment, and therefore are described briefly; for related parts, refer to partial descriptions in the method embodiment. The method embodiment described above is merely an example. The modules described as separate parts may or may not be physically separate. During implementation of the solutions of the embodiments of this specification, the function of the modules may be implemented in the same piece of or a plurality of pieces of software and/or hardware. A part or all of the modules may be selected according to actual needs to achieve the objectives of the solutions of the embodiments. A person of ordinary skill in the art may understand and implement this specification without creative efforts.

The foregoing descriptions are merely specific implementations of the embodiments of this specification. A person of ordinary skill in the art may make several improvements and modifications without departing from the principle of the embodiments of this specification and the improvements and modifications shall fall within the protection scope of the embodiments of this specification.

What is claimed is:

1. A risk decision-making method, comprising:
receiving, by a local server, a risk decision-making request initiated by a local service system, the risk decision-making request comprising service information of a local service;
performing, by a local server, a risk assessment on the local service using a first risk decision-making rule for the local service based on the service information of the local service, wherein the first risk decision-making rule is obtained from a central server;
determining, by the local server, a first risk assessment result for the local service from the risk assessment; and
determining, by the local server, a risk decision-making result for the local service based on the first risk assessment result.

2. The method according to claim 1, wherein the first risk decision-making rule includes one or more labels corresponding to one or more local merchants, and the first risk decision-making rule for each of the one or more merchants is packaged in the central server based on the one or more labels.

3. The method according to claim 1, further comprising:
performing, by the local server, a second risk assessment on the local service using a second risk decision-making rule based on the service information or the first risk assessment result, wherein the second risk decision-making rule is created locally at the local server, and
determining, by the local server, a second risk assessment result for the local service from the second risk assessment,
wherein the determining a risk decision-making result for the local service based on the first risk assessment result further comprises:
determining the risk decision-making result for the local service based on the first risk assessment result and the second risk assessment result.

4. The method according to claim 3, further comprising:
adjusting, by the local server, the second risk decision-making rule according to the risk decision-making result and the second risk assessment result in response to a determination that the determined risk decision-making result is different from the second risk assessment result.

5. The method according to claim 3, wherein the determining the risk decision-making result for the local service based on the first risk assessment result and the second risk assessment result further comprises:
determining the risk decision-making result for the local service based on the first risk assessment result and the second risk assessment result according to a preset rule, wherein the preset rule comprises:
determining the first risk assessment result as the risk decision-making result for the local service;
determining the second risk assessment result as the risk decision-making result for the local service; or
determining a risk assessment result with a higher priority in the first risk assessment result and the second risk assessment result as the risk decision-making result for the local service.

6. The method according to claim 1, further comprising:
determining a service category of the local service based on the service information of the local service; and
obtaining the first risk decision-making rule based on the service category of the local service.

7. The method according to claim 3, further comprising:
determining a service risk category of the local service based on the service information of the local service; and
obtaining the first risk decision-making rule based on the service risk category of the local service.

8. The method according to claim 7, further comprising:
obtaining the second risk decision-making rule based on the service risk category of the local service.

9. The method according to claim 1, wherein the risk assessment result for the local service is one of the following: a rejection of the local service; a further verification of the local service; and an acceptance of the local service.

10. A system comprising one or more processors and one or more non-transitory computer-readable memories coupled to the one or more processors and configured with instructions executable by the one or more processors to cause the system to perform operations comprising:
receiving a risk decision-making request initiated by a local service system, the risk decision-making request comprising service information of a local service;
performing a risk assessment on the local service using a first risk decision-making rule for the local service based on the service information of the local service, wherein the first risk decision-making rule is obtained from a central server;
determining a first risk assessment result for the local service from the risk assessment; and
determining a risk decision-making result for the local service based on the first risk assessment result.

11. The system according to claim 10, wherein the operations further comprise:
performing a second risk assessment on the local service using a second risk decision-making rule based on the service information or the first risk assessment result, wherein the second risk decision-making rule is created locally; and
determining a second risk assessment result for the local service from the second risk assessment;
wherein the determining a risk decision-making result for the local service based on the first risk assessment result further comprises:
determining the risk decision-making result for the local service based on the first risk assessment result and the second risk assessment result.

12. The system according to claim 11, wherein the operations further comprise:
adjusting the second risk decision-making rule according to the risk decision-making result and the second risk assessment result if the determined risk decision-making result is different from the second risk assessment result.

13. The system according to claim 11, wherein the determining the risk decision-making result for the local service based on the first risk assessment result and the second risk assessment result further comprises:
determining the risk decision-making result for the local service based on the first risk assessment result and the second risk assessment result according to a preset rule, wherein the preset rule comprises:
determining the first risk assessment result as the risk decision-making result for the local service;
determining the second risk assessment result as the risk decision-making result for the local service; or
determining a risk assessment result with a higher priority in the first risk assessment result and the second risk assessment result as the risk decision-making result for the local service.

14. The system according to claim 10, wherein the operations further comprise:
determining a service category of the local service based on the service information of the local service; and
obtaining the first risk decision-making rule based on the service category of the local service.

15. The system according to claim 11, wherein the operations further comprise:
determining a service risk category of the local service based on the service information of the local service; and
obtaining the first risk decision-making rule based on the service risk category of the local service.

16. The system according to claim 15, wherein the operations further comprise:
obtaining the second risk decision-making rule based on the service risk category of the local service.

17. The system according to claim 10, wherein the risk assessment result for the local service is one of the following: a rejection of the local service, a further verification of the local service, and an acceptance of the local service.

18. One or more non-transitory computer-readable storage media storing instructions executable by one or more processors, wherein execution of the instructions causes the one or more processors to perform operations comprising:
receiving a risk decision-making request initiated by a local service system, the risk decision-making request comprising service information of a local service;
performing a risk assessment on the local service using a first risk decision-making rule for the local service based on the service information of the local service, wherein the first risk decision-making rule is obtained from a central server;
determining a first risk assessment result for the local service from the risk assessment; and
determining a risk decision-making result for the local service based on the first risk assessment result.

19. The one or more non-transitory computer-readable storage media according to claim 18, wherein the operations further comprise:
performing a second risk assessment on the local service using a second risk decision-making rule based on the service information or the first risk assessment result, wherein the second risk decision-making rule is created locally; and
determining a second risk assessment result for the local service from the second risk assessment;
wherein the determining a risk decision-making result for the local service based on the first risk assessment result further comprises:
determining the risk decision-making result for the local service based on the first risk assessment result and the second risk assessment result.

20. The one or more non-transitory computer-readable storage media according to claim 19, wherein the determining the risk decision-making result for the local service based on the first risk assessment result and the second risk assessment result comprises:
determining the risk decision-making result for the local service based on the first risk assessment result and the second risk assessment result according to a preset rule, wherein the preset rule comprises:
determining the first risk assessment result as the risk decision-making result for the local service;
determining the second risk assessment result as the risk decision-making result for the local service; or
determining a risk assessment result with a higher priority in the first risk assessment result and the second risk assessment result as the risk decision-making result for the local service.
